(19) United States
(12) Patent Application Publication
(10) Pub. No.: US 2026/0049526 A1
(43) Pub. Date: Feb. 19, 2026

(54) SUPPORT CONNECTOR OBSTACLE DETECTION

(71) Applicant: MECHOSHADE SYSTEMS, LLC, Middleton, WI (US)

(72) Inventor: STEPHEN P. HEBEISEN, Amawalk, NJ (US)

(73) Assignee: MECHOSHADE SYSTEMS, LLC, Middleton, WI (US)

(21) Appl. No.: 19/303,135

(22) Filed: Aug. 18, 2025

Related U.S. Application Data
(60) Provisional application No. 63/684,794, filed on Aug. 19, 2024.

(51) Int. Cl. E06B 9/42; E06B 9/68

(52) U.S. Cl. CPC E06B 9/42; E06B 9/68; E06B 2009/6836

(57) ABSTRACT

The window shade system may comprise a shade tube having an inner portion, wherein at least a portion of the inner portion includes a conductive layer having current traveling through the conductive layer; a shade wound around the shade tube; a support connector received within the shade tube, wherein the support connector includes one or more sensors, wherein the one or more sensors of the support connector detect a current, in response to the shade pulling on the shade tube due to impacts of gravity on the shade, and wherein the one or more sensors of the support connector detect a change in current, in response to the shade impacting an obstacle.

### CROSS-REFERENCE TO RELATED APPLICATIONS

This disclosure claims priority to, and the benefit of, U.S. provisional patent application No. 63/684,794 filed on Aug. 19, 2024 and entitled “Support Connector Obstacle Detection,” which is incorporated herein by reference in its entirety for all purposes.

### TECHNICAL FIELD

This disclosure generally relates to obstacle detection in a window shade system, and more particularly, to a sensor on a support connector that is configured to detect if a window shade may have impacted an obstacle.

### BACKGROUND

Roller shade systems typically include a window covering (e.g., shade) attached to a shade tube, wherein the window covering rolls up onto, and rolls off of, the shade tube. The shade tube is mounted between brackets and at least one of the brackets is connected to a series of mechanical components such as gears, bearings, clutches, shafts, sprockets and hubs. The shade tube may be driven by a motor or a bead chain (with the bead chain interfacing with the sprocket). Pulling on the bead chain rotates the sprocket, which opens up the clutch (e.g., spring). The clutch may include a wrap spring such as the wrap spring disclosed in U.S. Pat. No. 6,164,428 entitled “Wrap Spring Shade Operator”, which is hereby incorporated by reference in its entirety for all purposes. Opening the clutch allows rotation of a driving hub attached to the tube. The driving hub rotation causes the rotation of the tube, and the rotation of the tube lowers (or raises) the shade.

Multiple of these shade tubes may be connected by a support connector, as shown in FIG. 1. When the motor or chain drives a first shade tube (e.g., motor band shown in FIG. 2), then the driving force is also provided to the second shade tube (e.g., idle band shown in FIG. 2) due to the support connector connecting the first shade tube to the second shade tube.

### SUMMARY

In various embodiments, the window shade system may comprise a shade tube having an inner portion, wherein at least a portion of the inner portion includes a conductive layer having current traveling through the conductive layer; a shade wound around the shade tube; a support connector received within the shade tube, wherein the support connector includes one or more sensors, wherein the one or more sensors of the support connector detect a current, in response to the shade pulling on the shade tube due to impacts of gravity on the shade, and wherein the one or more sensors of the support connector detect a change in current, in response to the shade impacting an obstacle.

In various embodiments, the one or more sensors of the support connector may be configured to detect a reduced current as the change in the current, in response to the shade impacting the obstacle. The one or more sensors of the support connector may be configured to detect a lack of current as the change in the current, in response to the shade impacting the obstacle. The system may determine that the obstacle does not exist, during a time period when the shade tube is changing directions and the one or more sensors of the support connector detect the change in the current. The shade tube may include a tube adapter having the inner portion.

In various embodiments, the one or more sensors of the support connector may be configured to electrically interface with at least a portion of the inner portion of the shade tube. The one or more sensors of the support connector may be configured to physically interface with at least a portion of the inner portion of the shade tube. The one or more sensors of the support connector may be configured to not interface at different times with at least a portion of the inner portion of the shade tube. A different portion of the one or more sensors of the support connector may be configured to interface with at least a portion of the inner portion of the shade tube. Different areas of the same sensor of the support connector may be configured to interface at different times with at least a portion of the inner portion of the shade tube. Different sensors of the one or more sensors of the support connector may be configured to interface at different times with at least a portion of the inner portion of the shade tube. The change in current, in response to the shade impacting the obstacle, may include at least one of detecting any current, detecting less current or detecting more current over a time period. The system may further comprise transmitting the change in current to at least one of a controller, motor, network or any other component of the system. The system may further comprise transmitting information about the shade impacting the obstacle to at least one of a controller, motor, network or any other component of the system.

In various embodiments, the window shade system may comprise a shade tube having an inner portion, wherein at least a portion of the inner portion includes one or more sensors; a shade wound around the shade tube; a support connector received within the shade tube, wherein the at least a portion of the support connector includes a conductive layer having current traveling through the conductive layer, wherein the one or more sensors of the inner portion of the shade tube are configured to detect a current, in response to the shade pulling on the shade tube due to impacts of gravity on the shade, and wherein the one or more sensors of the inner portion of the shade tube are configured to detect a change in current, in response to the shade impacting an obstacle.

### BRIEF DESCRIPTION OF THE DRAWINGS

The accompanying drawings, wherein like numerals depict like elements, illustrate exemplary embodiments of the present disclosure, and together with the description, serve to explain the principles of the disclosure.

FIG. 1 illustrates an exemplary support connector, in accordance with various embodiments; and

FIG. 2 illustrates two embodiments of an exemplary support connector inside a shade tube, wherein the first embodiment shows the position of the support connector when the shade tube is winding-up the shade, and the second embodiment shows the position of the support connector when the shade tube is winding-down the shade, in accordance with various embodiments.

### DETAILED DESCRIPTION

When multiple shades (e.g., 2-6 shade tubes 105) are installed (e.g., adjacent to each other) across a large window, each shade would typically need its own drive bracket (with its own sprocket, chain, etc.) that controls the movement of the single shade. However, a shading system may also include a multi-banded system in which a multitude of individual shade tubes 105 are driven by a single manual drive chain or motor that interfaces with a first shade. A shade tube 105 may consist of a shade band, a tube adapter, and a fabric band. The fabric band may comprise a spline (which may be welded to the top of the fabric) and the hembar (which may be attached to the bottom of the fabric).

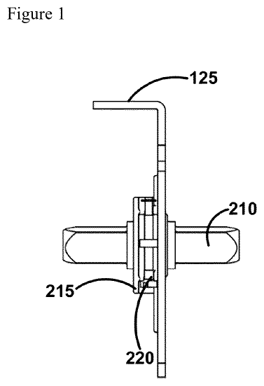

In various embodiments, the system drives multiple shade tubes 105 through a single chain or single motor by using one or more support connectors 210 (e.g., each may be a multi-band coupler between two shade tubes 105), as shown in FIG. 1. The support connector 210 fits within or through an accompanying bracket 125 between each shade tube 105. For example, the center-support brackets 125 in a multi-banded system typically include a support connector 210 that goes through the center-support bracket 125, such that a first shade tube 105 interfaces with the support connector 210 on the first side of the bracket 125 and a second shade tube 105 also interfaces with the support connector 210 on the second side of the bracket 125. Support connector 210 may rotate with the shade tube 105. In particular, support connector 210 may rotate on both sides of the bracket because a first shade tube 105 is rotating with a first side of support connector 210 and a second shade tube 105 is rotating with a second side of support connector 210. A single drive bracket 125 may be configured at one end of the group of shade tubes 105 being controlled. A motor (or pulling on the chain) drives a first shade tube 105 attached to the drive bracket 125, which is coupled to two or more shade tubes 105, wherein each shade tube 105 is driven via a support connector 210 in a serial fashion from the first shade tube 105. As such, a third shade tube 105 may connect to a second support connector 210, such that the second support connector 210 connects the second shade tube 105 and the third shade tube 105. Similarly, a fourth shade tube 105 may connect to a third support connector 210, such that the third support connector 210 connects the third shade tube 105 and the fourth shade tube 105. In this way, any number of shade tubes 105 may be connected with a support connector 210 between each pair of shade tubes 105.

When the shade is mounted on a shade tube 105, gravity may pull the shade downwards toward the floor, which forces one or more portions (e.g., sides and/or corners) of support connector 210 to interface with the inner portion 230 of the shade tube 105. In particular, support connector 210 may interface with the inner portion 230 of the shade tube 105 because, while the support connector 210 fits within the shade tube 105, some extra space may exist that allows the support connector 210 to adjust or rotate, relative to the inner portion 230 of the shade tube 105. As used herein, shade tube 105 may include a shade tube 105 having a tube adapter. As such, any references to inner portion 230 of the shade tube 105 may also or alternatively include the inner portion 230 of the tube adapter.

The system may detect the interfacing of the support connector 210 with the inner portion 230 of the shade tube 105. For example, the system may detect the interfacing of one or more faces and/or one or more corners of the support connector 210 with the inner portion 230 of the shade tube 105. In various embodiments, the inner portion 230 of the shade tube 105 may include a conductive material and current may run through the conductive material. In this regard, the shade tube may directly or indirectly interface with a power source to provide the energy that creates the current that travels through the conductive material in the inner portion 230 of the shade tube 105. Moreover, the system may include sensors 225 on portions of the support connector 210. As such, the system is configured to detect an interfacing (or near interfacing) of the one or more sensors 225 on the support connector 210 and the inner portion 230 of the shade tube 105. In particular, when the sides of support connector 210 come close to or push against the inner portion 230 of the shade tube 105, the sensors 225 of support connector 210 may detect the current traveling through the inner portion 230 of the shade tube 105. In various embodiments, the sensors 225 of support connector 210 may include electrical current sensors 225 in the form of pads. One or more of the sensors 225 may be incorporated into any area or region of the support connector 210 such as, for example, the faces, corners or ends. Moreover, for any of the embodiments, the system may include an alternative version, wherein the conductive surface is on the support connector 210 and the sensors 225 are on the inner portion 230 of the shade tube 105, such that the sensors 225 on the shade tube 105 read the current going through the support connector 210. In various embodiments, while the system may be described as providing and detecting current, the system may also include providing and detecting voltage, light, fluid and/or any other detectable item using similar and suitable configurations.

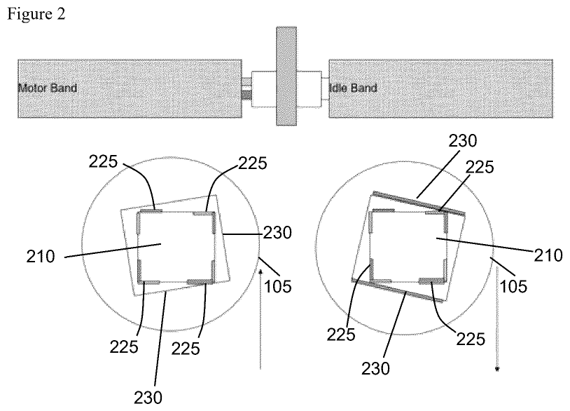

The specific locations where the sensors 225 and the inner portion 230 of the shade tube 105 interface may vary depending on the actions of the shade tube 105. FIG. 2 shows two embodiments of an exemplary support connector 210 inside a shade tube 105. For example, a first embodiment shows a first position of the support connector 210, when the shade tube 105 is winding-up the shade. As shown in FIG. 2, certain portions of support connector 210 may interface with the inner portion 230 of the shade tube 105, while the shade tube 105 is winding-up the shade. At least a portion of one or more of the sensors 225 may be the areas that interface with the inner portion 230 of the shade tube 105. The second embodiment shows a second position of the support connector 210, while the shade tube 105 is winding-down the shade. As also shown in FIG. 2, different portions of support connector 210 may interface (e.g., physically or electrically) with the inner portion 230 of the shade tube 105, while the shade tube 105 is winding-down the shade. The interface points on support connector 210 may include any portion of one or more of the sensors 225. The interfacing may include an electrical interface, wherein the one or more sensors may not physically interface with the inner portion 230 of the shade tube 105, but the one or more sensors 225 may detect the current from the inner portion 230 of the shade tube 105. The interfacing may include the one or more sensors both physically interfacing with the inner portion 230 of the shade tube 105, and the one or more sensors 225 detecting the current from the inner portion 230 of the shade tube 105. As used herein, a different portion of the one or more sensors interfacing with the inner portion 230 of the shade tube 105 may include a different area of the same sensor interfacing or a different sensor interfacing. At certain points, the sides of support connector 210 may be parallel (or almost parallel) to the inner portion 230 of the shade tube 105, so the components may not physically interface. Moreover, in both embodiments (winding-up and winding-down), some of the same portions of support connector 210 may interface with the inner portion 230 of the shade tube 105.

As mentioned above, gravity may pull the shade downwards toward the floor, which forces one or more the sides and/or corners of support connector 210 to interface with the inner portion 230 of the shade tube 105. However, if the shade hits an obstacle, the shade may not (or may not fully) pull on the shade tube 105. If the shade does not sufficiently pull on the shade tube 105, then then support connector 210 may not sufficiently interface with the inner portion 230 of the shade tube 105 for a certain time period. As such, one or more of the sensors 225 on support connector 210 (e.g., on faces, corners and/or ends) may detect a change in the current through the inner portion 230 of the shade tube 105 for that time period. The change in current may include, for example, no longer detecting any current, detecting less current or detecting more current. Such a time period may be a very short time (e.g., 1-2 seconds) due to the quick impact of the shade with an obstacle. The system may detect a change in current and/or detect a lack of current, so the system may determine that current change may be based on an obstacle restricting the shade from pulling on the shade tube 105. However, if the change in current and/or lack of current exists during a time period when the shade tube 105 is changing directions, then the system may determine that an obstacle is not the cause of the lack of current. As used herein, a change of current may include a reduction of current, increase in current, or lack of current. The system may or may not interpret the lack of current to be an obstacle, if the lack of current is in fact a reduction of current. The system may use artificial intelligence, machine learning, modeling and/or algorithms to analyze the change in current to determine if an obstacle may be the cause of the change in current.

In various embodiments, the system may communicate the change in current and/or obstacle information to a controller, motor, a network (e.g., internet) and/or any other component. The communication may include wired and/or wireless communication. In various embodiments, the system may also provide power to the inner portion 230 of the shade tube 105 and/or the one or more of the sensors 225 on support connector 210. The power and/or communication may be supplied via different types of wiring schemes or power over ethernet (POE).

The system may include other obstacle detection features such as found in, for example, U.S. Ser. No. 18/086,421 filed Dec. 21, 2022 and entitled “Modular Motor with Obstacle Detection for a Window Shade System,” which is hereby incorporated in their entirety by reference for all purposes.

The system may include support connector features and functions such as found in, for example, U.S. Ser. No. 18/101,243 filed Jan. 25, 2023 and entitled “Support Connector Lock”; U.S. Ser. No. 17/473,400 filed Sep. 13, 2021, now U.S. Pat. No. 11,591,852 issued Feb. 28, 2023 and entitled “Support Connector Lock”; and U.S. Ser. No. 16/654,895 filed Oct. 16, 2019, now U.S. Pat. No. 11,261,661 issued Mar. 1, 2022 and entitled “Roller Shade System,” all of which are hereby incorporated in their entirety by reference for all purposes.

The roller shade system may be controlled by a shade control system such as found in, for example, U.S. Ser. No. 14/692,868 filed on Apr. 22, 2015 and entitled “Automated Shade Control System Interaction With Building Management System”; PCT Application No. PCT/US2013/066316 filed on Oct. 23, 2013 and entitled “Automated Shade Control System Utilizing Brightness Modeling”; PCT Application No. PCT/US2013/066316; U.S. Ser. No. 13/671,018 filed on Nov. 7, 2012, now U.S. Pat. No. 8,890,456 entitled “Automated Shade Control System Utilizing Brightness Modeling”; U.S. Ser. No. 13/556,388 filed on Jul. 24, 2012, now U.S. Pat. No. 8,432,117 entitled “Automated Shade Control System”; U.S. Ser. No. 13/343,912 filed on Jan. 5, 2012, now U.S. Pat. No. 8,248,014 entitled “Automated Shade Control System”; U.S. Ser. No. 12/475,312 filed on May 29, 2009, now U.S. Pat. No. 8,120,292 entitled “Automated Shade Control Reflectance Module”; U.S. Ser. No. 12/421,410 filed on Apr. 9, 2009, now U.S. Pat. No. 8,125,172 entitled “Automated Shade Control Method and System”; U.S. Ser. No. 12/197,863 filed on Aug. 25, 2008, now U.S. Pat. No. 7,977,904 entitled “Automated Shade Control Method and System”; U.S. Ser. No. 11/162,377 filed on Sep. 8, 2005, now U.S. Pat. No. 7,417,397 entitled “Automated Shade Control Method and System”; U.S. Ser. No. 10/906,817 filed on Mar. 8, 2005, and entitled “Automated Shade Control Method and System”; and U.S. Provisional No. 60/521,497 filed on May 6, 2004, and entitled “Automated Shade Control Method and System,” all of which are hereby incorporated in their entirety by reference for all purposes.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

I claim:

1. A window shade system comprising:
a shade tube having an inner portion,
wherein at least a portion of the inner portion includes a conductive layer having current traveling through the conductive layer;
a shade wound around the shade tube;
a support connector received within the shade tube,
wherein at least a portion of the support connector includes one or more sensors,
wherein the one or more sensors of the support connector are configured to detect a current, in response to the shade pulling on the shade tube due to impacts of gravity on the shade, and
wherein the one or more sensors of the support connector are configured to detect a change in current, in response to the shade impacting an obstacle.

2. The system of claim 1, wherein the one or more sensors of the support connector are configured to detect a reduced current as the change in the current, in response to the shade impacting the obstacle.

3. The system of claim 1, wherein the one or more sensors of the support connector are configured to detect a lack of current as the change in the current, in response to the shade impacting the obstacle.

4. The system of claim 1, further comprising determining that the obstacle does not exist, during a time period when the shade tube is changing directions and the one or more sensors of the support connector detect the change in the current.

5. The system of claim 1, wherein the shade tube has a tube adapter having the inner portion.

6. The system of claim 1, wherein the one or more sensors of the support connector are configured to electrically interface with at least a portion of the inner portion of the shade tube.

7. The system of claim 1, wherein the one or more sensors of the support connector are configured to physically interface with at least a portion of the inner portion of the shade tube.

8. The system of claim 1, wherein the one or more sensors of the support connector are configured to not interface at different times with at least a portion of the inner portion of the shade tube.

9. The system of claim 1, wherein a different portion of the one or more sensors of the support connector are configured to interface with at least a portion of the inner portion of the shade tube.

10. The system of claim 1, wherein different areas of the same sensor of the support connector are configured to interface at different times with at least a portion of the inner portion of the shade tube.

11. The system of claim 1, wherein different sensors of the one or more sensors of the support connector are configured to interface at different times with at least a portion of the inner portion of the shade tube.

12. The system of claim 1, wherein the change in current, in response to the shade impacting the obstacle, includes at least one of detecting any current, detecting less current or detecting more current over a time period.

13. The system of claim 1, further comprising transmitting the change in current to at least one of a controller, motor, network or any other component of the system.

14. The system of claim 1, further comprising transmitting information about the shade impacting the obstacle to at least one of a controller, motor, network or any other component of the system.

15. A window shade system comprising:
a shade tube having an inner portion,
wherein at least a portion of the inner portion includes one or more sensors;
a shade wound around the shade tube;
a support connector received within the shade tube,
wherein the at least a portion of the support connector includes a conductive layer having current traveling through the conductive layer,
wherein the one or more sensors of the inner portion of the shade tube are configured to detect a current, in response to the shade pulling on the shade tube due to impacts of gravity on the shade, and
wherein the one or more sensors of the inner portion of the shade tube are configured to detect a change in current, in response to the shade impacting an obstacle.

16. The system of claim 15, wherein the one or more sensors of the inner portion of the shade tube are configured to detect a reduced current as the change in the current, in response to the shade impacting the obstacle.

17. The system of claim 15, wherein the one or more sensors of the inner portion of the shade tube are configured to detect a lack of current as the change in the current, in response to the shade impacting the obstacle.

18. The system of claim 15, further comprising determining that the obstacle does not exist, during a time period when the shade tube is changing directions and the one or more sensors of the inner portion of the shade tube detect the change in the current.

19. The system of claim 15, wherein the change in current, in response to the shade impacting the obstacle, includes at least one of detecting any current, detecting less current or detecting more current over a time period.

20. The system of claim 15, further comprising transmitting at least one of the change in current or information about the shade impacting the obstacle to at least one of a controller, motor, network or any other component of the system.
